(19) United States
(12) Patent Application Publication
(10) Pub. No.: US 2007/0026863 A1
(43) Pub. Date: Feb. 1, 2007

(54) Method and apparatus to facilitate scanning in a wireless local area network

(76) Inventors: Timothy J. Wilson, Rolling Meadows, IL (US); Brian K. Smith, Wellington, FL (US)

Correspondence Address: MOTOROLA, INC., 1303 EAST ALGONQUIN ROAD, IL01/3RD, SCHAUMBURG, IL, 60196, US

(21) Appl. No.: 11/190,681

(22) Filed: Jul. 27, 2005

(51) Int. Cl. H04Q 7/20

(52) U.S. Cl. 455/437

(57) ABSTRACT

A wireless two-way communications apparatus (700) having a radio resource manager (706) is configured and arranged to effect one or more modes of operation (203, 204, 206, and 207) as a function, at least in part, of whether the apparatus is presently operating in a power saving mode of operation (201) and/or is presently supporting an active plesiochronous communication session (202 and 205). Pursuant to one approach, when the apparatus is operating in a power saving mode of operation and presently supports such a communication session and when the apparatus further determines (301) that a wireless access point beacon or supplemental beacon is at least largely coincident with a scheduled active window of that communication session, the apparatus can determine (302) whether to facilitate rescheduling a next monitoring of the beacon or supplemental beacon and/or altering the scheduled active window itself to thereby render the beacon or supplemental beacon monitorable by the apparatus.

### TECHNICAL FIELD

This invention relates generally to communication systems and more particularly to wireless communication systems having multiple potential and/or actual points of attachment.

### BACKGROUND

Communication systems, including wireless communication systems, of various kinds are known in the art. In many cases such systems present a plurality of multiple potential and/or actual points of attachment. In some cases this architecture permits a wireless two-way communications device to roam within the system without breaking an essentially continuous state of attachment notwithstanding a relatively small coverage area for each (or at least some) of the points of attachment. In other cases this architecture permits a wireless two-way communications device to receive service through multiple points of attachment simultaneously (as when, for example, the system employs spread spectrum techniques that can leverage the availability of multiple points of simultaneous attachment).

Notwithstanding such benefits, these kinds of systems also often face significant support issues. For example, to ensure adequate quality of service levels for a relatively large user population care must be taken to ensure that unneeded resources are not essentially squandered while attempting to ensure the quality of service for a given particular user. This, in turn, often requires relatively frequent monitoring of presently used and potentially usable system resources. To facilitate such radio resource management, some systems provide for periodic transmission of a beacon signal by the system's edge elements. These beacon signals are transmitted at predictable points in time and typically comprise known content. Receiving users are then able to compare the received signal against known or expected characteristics and thereby derive a measure of the present quality of signals as are transmitted by these corresponding points of attachment. Such information is then employed by the user to inform various radio resource management decisions and actions (such as initiating a presence update, initiating a handover, initiating a receiving signal strength indication update, initiating a transmit power update, and so forth).

Such beacons, while relatively effective for the purposes described, are not always a complete solution in and of themselves. For example, such beacons are typically only transmitted on an occasional basis. Derived quality of service information can sometimes become unduly stale during the intervening period between such transmissions. It has therefore been proposed that supplemental beacons be also provided in addition to such primary beacons (where “supplemental beacons” are understood to comprise an additional periodic beacon having reduced content as compared to the primary beacon). By one suggested approach a number of such supplemental beacons may be transmitted between primary beacon broadcasts.

Such supplemental beacons do indeed improve the likelihood that a given subscriber unit will more likely have fresher quality of service information. Unfortunately, however, the realities of network operations again sometimes frustrate achievement of a fully adequate solution. In particular, during at least some modes of operation, a given user may be unable to receive such supplemental beacons. For example, when operating in a power saving mode of operation and while also engaged in an active plesiochronous (i.e. running in a state where different parts of the network are almost, but not quite perfectly synchronized) communication session with a given wireless access point, the scheduled active window as characterizes that communication session may be partially or wholly coincident in time with a beacon or supplemental beacon transmission of interest. Given the plesiochronous nature of the communication session itself, this condition may, or may not, persist for a considerable period of time. This, in turn, can effectively prevent the user from receiving the beacon or supplemental beacon of interest and thereby frustrate the needs of radio resource management.

### BRIEF DESCRIPTION OF THE DRAWINGS

The above needs are at least partially met through provision of the method and apparatus to facilitate scanning in a Wireless Local Area Network described in the following detailed description, particularly when studied in conjunction with the drawings, wherein:

FIG. 1 comprises a downlink/uplink schematic traffic diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention;

FIG. 6 comprises a flow diagram as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a radio resource management process takes active plesiochronous communication session status into account when determining a corresponding mode of operation for a given wireless two-way communications device. In a preferred approach this further comprises taking power saving mode of operation states into account as well.

For example, when a given two-way device presently supports an active plesiochronous communication session while also maintaining a power saving mode of operation, a first mode of operation can be automatically determined and, preferably, effected. In a preferred embodiment, for example, this first mode of operation can comprise determining whether a wireless access point's scheduled beacon or supplemental beacon is at least partially coincident with a scheduled active window as corresponds to the active plesiochronous communication session. When this condition exists, a determination can then be made whether, for example, to reschedule monitoring of the beacon or supplemental beacon for a later time (based, for example, upon calculated slippage as between clocked behavior of the wireless two-way communications device itself and the corresponding wireless access point), to alter the presently scheduled active window in some manner (for example, by moving forward, delaying, contracting, and/or expanding the corresponding activity), and/or to take some other corresponding action (for example, to automatically transmit an active probe to prompt a near-term response from the wireless access point of interest).

So configured, a user platform can supplement its radio resource management options and capabilities by effectively increasing its ability to garner potentially useful information regarding presently available system resources and the quality of service as presently corresponds to such resources. In many cases this can be accomplished without disrupting (or at least unduly disrupting) a presently active plesiochronous communication session.

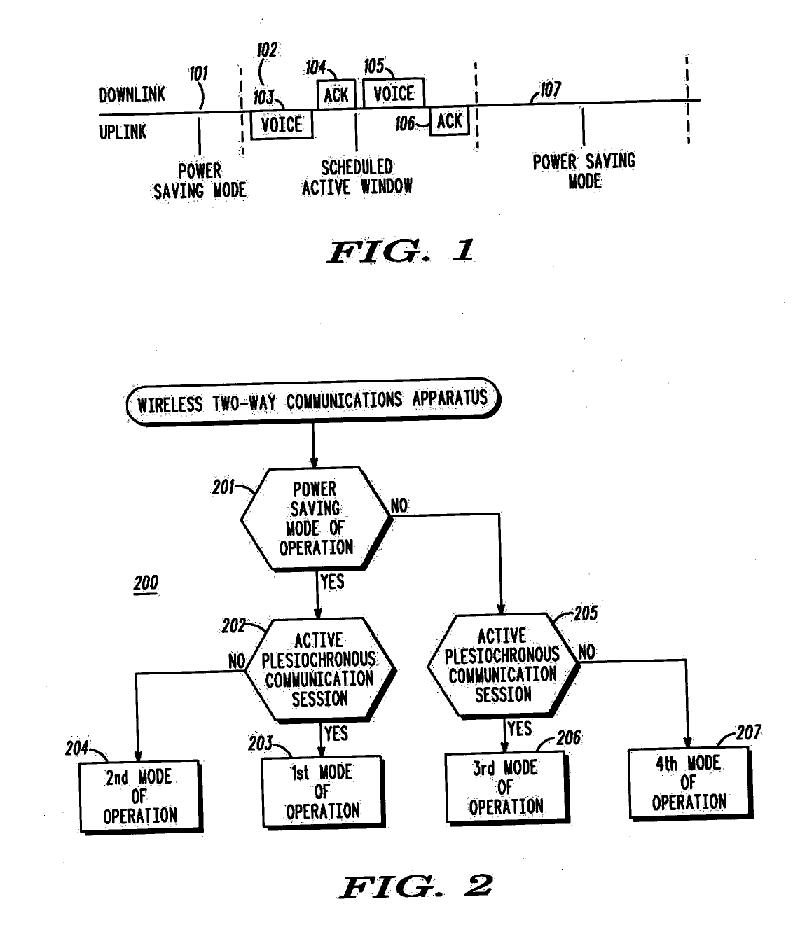

These and other benefits may become clearer upon making a thorough review and study of the following detailed description. Referring now to the drawings, and in particular to FIG. 1, it may be helpful to first describe an illustrative context within which these teachings may be usefully employed. Those skilled in the art will understand and appreciate that this context serves only for the purposes of illustration only and does not constitute an exhaustive description of all possibly useful settings.

When operating in a power saving mode of operation, a two-way communication device will typically enter a so-called sleep mode from time to time during which its transmission and/or reception activities are curtailed. That device will then occasionally assume a more active state to facilitate its transmission and/or reception activities. In many cases, as when the two-way communications device is engaged in an active plesiochronous communication session, these events will tend to occur on a relatively periodic basis. For example, when the active plesiochronous communication session comprises a Voice over Internet Protocol (VoIP) session, the two-way device may alternative between sleep periods (denoted in FIG. 1 by reference numerals 101 and 107) having a relatively fixed duration (such as, for example, 20 milliseconds) and scheduled active windows (with one such active window being shown in FIG. 1 and being denoted by reference numeral 102). During such a scheduled active window 102, the two-way device may transmit a voice message 103 that is acknowledged with an acknowledgment message 102 by, for example, a wireless access point. The two-way device may also receive a voice message 105 from this wireless access point which the two-way device, in turn, will acknowledge 106.

Other activities can of course occur during such a scheduled active window 102 as may be desired and/or required as per the needs of a given application setting. This illustrative example should suffice, however, to suggest the difficulties that can arise when a beacon or supplemental beacon as is transmitted by one or more wireless access points of interest happens to coincide with such a scheduled active window. The problem is exacerbated, of course, when beacon or supplemental beacon transmissions happen to exhibit a periodicity that essentially matches the scheduling of the active window 102. Under such conditions, the two-way device may be forced to wait a considerable period of time before being able to successfully receive information useful to its radio resource management processing requirements.

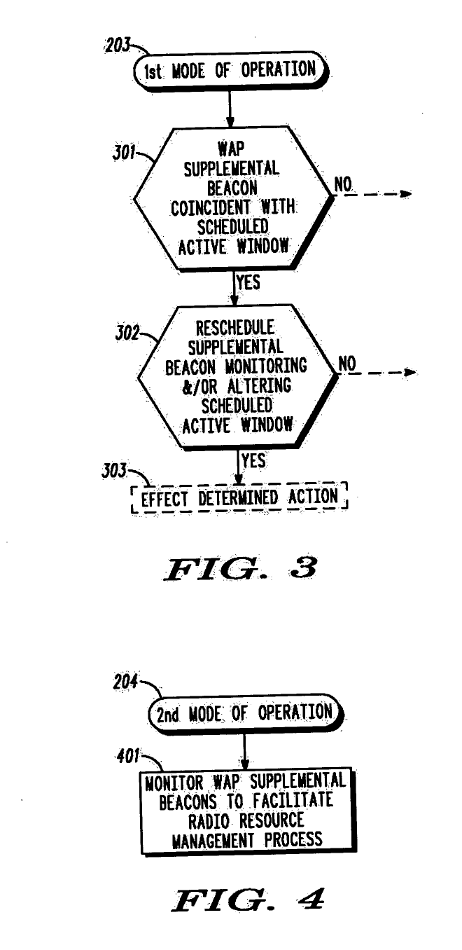

FIG. 2 sets forth a general overview of a process 200 that aids in resolving the problems presented by such circumstances. In a preferred approach this process 200 is conducted by a wireless two-way communications apparatus such as, but not limited to, a cellular telephone, a portable telephone, a wireless local area network device, and so forth. In general, this process 200 provides for various modes of operation depending upon whether the two-way device is presently engaged in a power saving mode of operation and further depending upon whether the two-way device is presently engaged in an active plesiochronous communication session with a wireless access point (such as, but not limited to, an 802.11-family compatible wireless access point as is known in the art).

For example, in this particular embodiment, the process 200 first determines 201 whether the two-way device is presently effecting a power saving mode of operation (wherein it will be understood that the precise meaning of “power saving mode of operation” will vary from platform to platform as well as from communications protocol to protocol but will, in general, tend to at least encompass the notion of comprising an automatically engaged less-active mode of operation that consumes less power than an also supported more-active mode of operation). Pursuant to this illustrative embodiment the two-way device then further determines 202 and 205 whether the two-way device is also presently engaged in supporting an active plesiochronous communication session.

So configured, this process 200 provides for a first mode of operation 203 when supporting both a power saving mode of operation and an active plesiochronous communication session and a second mode of operation 204 when supporting a power saving mode of operation but not also an active plesiochronous communication session. In a preferred embodiment this process 200 further provides for a third mode of operation 206 when supporting an active plesiochronous communication session but not a power saving mode of operation and a fourth mode of operation 207 when not presently supporting either an active plesiochronous communication session or a power saving mode of operation. Elaboration regarding each such mode of operation will now be provided.

Referring now to FIG. 3, the first mode of operation 203 will be described. In a preferred approach the first mode of operation 203 will determine 301 whether the scheduled active window as comprises a part of the active plesiochronous communication session is at least substantially coincident with a next transmission of a beacon or supplemental beacon as is to be transmitted by at least one of the wireless access point that also supports that active plesiochronous communication session and at least one other wireless access point. This determination 301 can be based upon such criteria and information as may be available to a given two-way device. In a preferred approach, however, this determination 301 can be based, at least in part, upon information that is available to the two-way device regarding clock information both for itself and for the wireless access point (or points) of interest.

When such coincidence is not evident, this mode of operation 103 can essentially conclude as the two-way device can continue forward using an existing technique of choice to effect reception of the beacon or supplemental beacon. When such a coincidence exists, however, the first mode of operation 103 will then preferably further determine 302 whether to reschedule a first monitoring of the beacon or supplemental beacon to a future time when the beacon or supplemental beacon is at least largely not coincident with a scheduled active window of the active plesiochronous communication session and/or to alter the at least one scheduled active window of the active plesiochronous communication session to provide an active window having an altered schedule such that the beacon or supplemental beacon is at least largely not coincident with the active window having the altered schedule.

Rescheduling can be based as a function, at least in part, of calculated slippage as between clocked behavior of the two-way device itself and the first wireless access point. More particularly, in many cases the two-way device may have sufficient information regarding the clock rate and clock count schedule of the wireless access point in question to permit a useful comparison to its own internal clock. In many cases, due either to clock rate variations or clock count scheduling, the scheduled activities of both platforms will not remain in lock step indefinitely. More particularly, in at least some cases the two-way device may be able to conclude that, although the beacon or supplemental beacon transmissions of the wireless access point are presently coincident, these events will be sufficiently non-coincident in the near future due to clock slippage. In such a case, monitoring may be acceptably postponed until the beacon or supplemental beacon transmission is sufficiently non-coincident with the active window to permit useful monitoring thereof.

In a case when such an analysis indicates that rescheduling will result in too long a delay before a beacon or supplemental beacon will be receivable outside of an active scheduled window, the two-way device can instead alter the scheduling of its own scheduled active window. Although in many cases the two-way device may not have total freedom in this regard, in many instances a certain degree of variation with respect to early or late initiation of an active scheduled window will be tolerated by the system. In such a case, the two-way device can calculate whether beacon or supplemental beacon reception can be accommodated by making a modest alteration to the scheduling of the active window.

These teachings also contemplate a combination of these two approaches. For example, it may be determined that a best compromise can be reached by both rescheduling beacon or supplemental beacon monitoring and altering the scheduled active window. These teachings also contemplate other actions as well. For example, in addition to the above alternative actions or in lieu thereof, it may be appropriate to permit the two-way device an option such as transmitting an active probe to thereby cause the wireless access point to respond with a response transmission that can then be monitored by the two-way device to gain the desired radio resource monitoring information.

Upon determining a particular course of action to take, this first mode of operation 103 then preferably effects 303 that determined action. So configured, notwithstanding that a given two-way device is both engaged in a power saving mode of operation and engaged in an active plesiochronous communication session, that two-way device is nevertheless able to take certain actions to increase its ability to monitor, at least in the relatively near term, a beacon or supplemental beacon that would otherwise occur coincident with those active plesiochronous communication sessions.

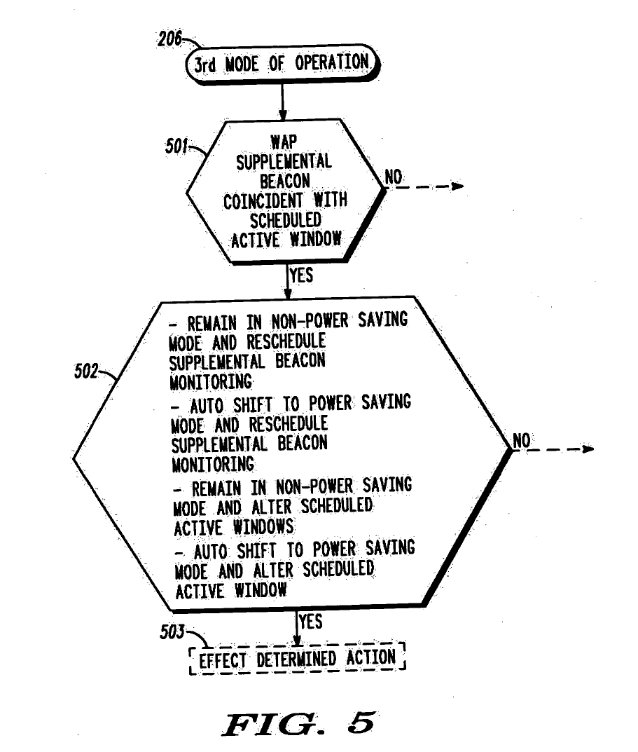

Referring now to FIG. 4, it will be recalled that the second mode of operation 204 occurs when the two-way device is presently acting in a power saving mode of operation but is not presently engaged in an active plesiochronous communication session. In such a case, the two-way device can simply monitor 401 the beacon or supplemental beacon as is transmitted by at least one of the wireless access points of interest to thereby facilitate its radio resource management process. That is, the two-way device can simply act to receive the beacon or supplemental beacon at the first scheduled transmission thereof without concern that such reception will interfere with an active plesiochronous communication session.

The above described modes of operation relate to when the two-way device is presently engaged in a power saving mode of operation. The next two modes of operation to be described pertain to circumstances that may prevail when the two-way device is not presently engaged in a power saving mode of operation.

Referring now to FIG. 5, and pursuant to the third mode of operation 206 (which engages, in this embodiment, when an active plesiochronous communication session occurs in the absence of a power saving mode of operation), the two-way device again determines 501 whether a beacon or supplemental beacon as is transmitted by at least one of a plurality of wireless access points of interest is at least substantially coincident with at least one scheduled active window of a present active plesiochronous communication session. When the latter condition does not exist, the two-way device can use any prior art technique of choice with respect to effecting monitoring of the beacon or supplemental beacon. When the latter condition does exist, however, in this preferred approach the two-way device then determines 502 whether and which of four different actions to facilitate. These actions, in this embodiment, comprise:
remaining in the non-power saving mode of operation and rescheduling a first monitoring of the beacon or supplemental beacon for a future time when the beacon or supplemental beacon is at least largely not coincident with a scheduled active window of the active plesiochronous communication session;
automatically shifting to a power saving mode of operation and rescheduling a first monitoring of the beacon or supplemental beacon for a future time when the beacon or supplemental beacon is at least largely not coincident with a scheduled active window of the active plesiochronous communication session;
remaining in the non-power saving mode of operation and altering the at least one scheduled active window of the active plesiochronous communication session to provide an active window having an altered schedule such that the beacon or supplemental beacon is at least largely not coincident with the active window having the altered schedule; and
automatically shifting to a power saving mode of operation and altering the at least one scheduled active window of the active plesiochronous communication session to provide an active window having an altered schedule such that the beacon or supplemental beacon is at least largely not coincident with the active window having the altered schedule.

If desired, and as illustrated, this determination step 502 can also provide for a determination that none of these actions be taken and that some other action (such as an existing prior art approach) be adopted instead. Upon selecting one of these options, however, the two-way device then effects 503 the selected approach to rescheduling beacon or supplemental beacon monitoring or altering the schedule active window. It will be understood and appreciated that this step can simply comprise, if desired, effectuation of only a single permitted option in this regard. Or, if desired, a dynamic selection can be performed at a time of need amongst two or more of these specific options. It will also be understood and appreciated that this step can comprise, if desired, a combination of two or more of the specified actions (for example, one may select both monitoring rescheduling and active window alteration in combination with one another).

The fourth mode of operation 207 occurs when the two-way device is neither engaged in a power saving mode of operation nor otherwise engaged in an active plesiochronous communication session. As illustrated in FIG. 6, this fourth mode of operation 207 can comprise a step wherein the two-way device determines whether to facilitate at least one of:
automatically shifting to a power saving mode of operation notwithstanding a present need to otherwise maintain the non-power saving mode of operation, monitoring the beacon or supplemental beacon as is transmitted by at least one of the wireless access points of interest, and then returning again to the non-power saving mode of operation;
automatically monitoring the beacon or supplemental beacon as is transmitted by the at least one other wireless access point (that is, a wireless access point other than the wireless access point to which the two-way device is otherwise currently attached) during the non-power saving mode of operation;
automatically shifting to a power saving mode of operation notwithstanding a present need to otherwise maintain the non-power saving mode of operation, transmitting an active probe, monitoring a response to the active probe as is transmitted by at least one of the wireless access points of interest, and returning to the non-power saving mode of operation; and
automatically transmitting an active probe during the non-power saving mode of operation and monitoring a response to the active probe as is transmitted by at least one of the wireless access points of interest.

Again, if desired, this step 601 of determining a particular action can further (optionally) provide for determining to effect instead an unspecified action (such as a prior art technique of choice). Upon choosing one of the specified options, however, in a preferred approach the two-way device then effects 602 the determined action.

So configured, it will be appreciated that a two-way device has a plurality of ways of responding to certain operational scenarios when seeking to monitor a beacon or supplemental beacon or to otherwise obtain relatively near-term quality of service information to support its radio resource management functionality. Many of these approaches are able to leverage any knowledge the two-way device has regarding both its own clock and the clock of the wireless access point of interest. More particularly, the two-way device is now able to take advantage, at least on some occasions, of calculated slippage as may occur between those two clocks in a plesiochronous communication session.

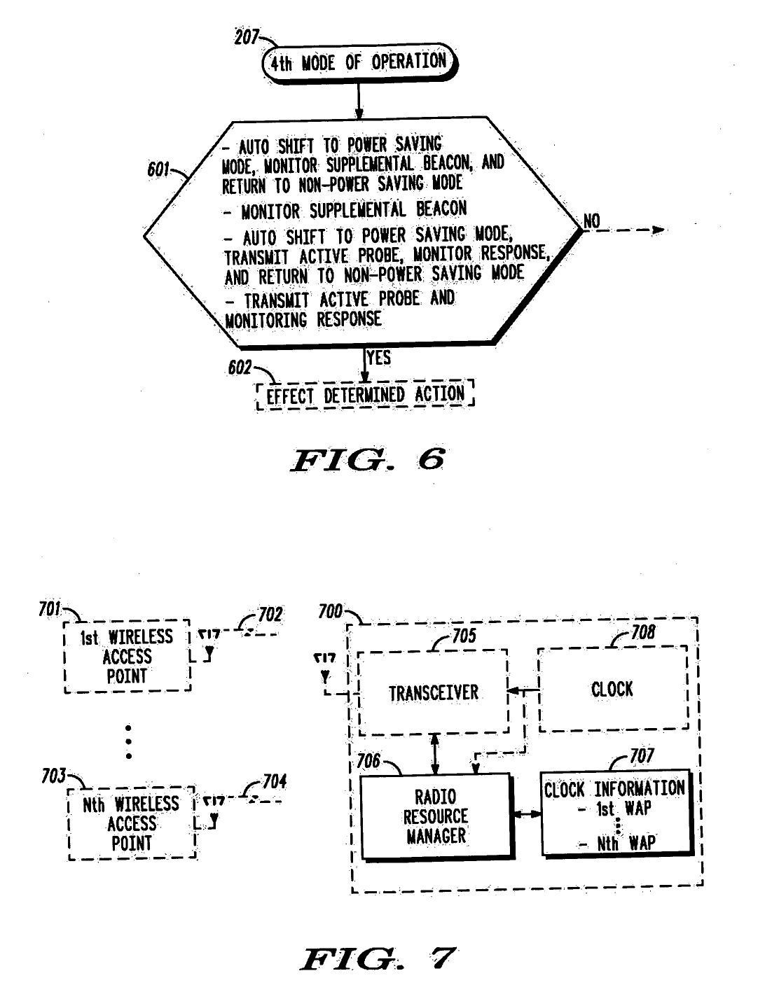

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will now be provided. An illustrative wireless two-way communications apparatus 700 will typically operate in conjunction with a plurality of wireless access points (represented here by a first wireless access point 701 through an Nth wireless access point 703 where “N” comprises any integer greater than “1”). In particular, this wireless two-way communications apparatus 700, at a minimum, receives wireless communications 702 and 704 as are sourced by these wireless access points including, but not limited to, both beacons and supplemental beacons as are designed and serve to facilitate radio resource management purposes.

In a preferred embodiment the wireless two-way communications apparatus 700 comprises a wireless transceiver 705 of choice to support the above-noted wireless communications. Such transceivers are generally well known in the art and require no further elaboration here. The transceiver 705 in turn operably couples to a radio resource manager 706 (which also is well known in the art). In accordance with known technique, the radio resource manager 706 serves, at least in part, to determine whether and when the transceiver 705 should become detached from a given wireless access point and/or to become attached to a given wireless access point. In addition, however, and in accord with a preferred embodiment, this radio resource manager 706 supplements this usual task by incorporating the teachings set forth above.

For example, the radio resource manager 706 is preferably configured and arranged (by, for example, programming alterations) to determine when a beacon or supplemental beacon as is transmitted by at least one of the wireless access points 701 and 703 is at least substantially coincident with at least one scheduled active window of an active plesiochronous communication session during a power saving mode of operation. Furthermore, and again in accordance with a preferred embodiment, the radio resource manager 706 is also configured arranged to respond to such a determination by then determining whether to facilitate at least one of a rescheduling action with respect to scheduled monitoring of that beacon or supplemental beacon and an altering action with respect to the scheduled active window itself in order to move these respective events from substantial coincidence to substantial temporal non-coincidence.

More particularly, and again with respect to a preferred presentation, the radio resource manager 706 is operably coupled and responsive to clock information for both the wireless two-way communications apparatus 700 itself and for one or more of the wireless access points 701 and 703 to aid in effectuating the above-described determination. For example, the radio resource manager 706 can be coupled to the clock 708 for the wireless two-way communications apparatus 700 and can further be coupled to a memory 707 that contains clock information for the wireless access points 701 and 703. The latter clock information can be gleaned through various means and techniques including, for example, as each beacon, supplemental beacon, or probe response is received, having the radio resource manager store the timestamp field from the frame which corresponds to the wireless access point's Timing Synchronization Function (TSF) and the current local Timing Synchronization Function value

So configured and arranged, the radio resource manager 706 can utilize this clock information for both itself and for one or more of the wireless access points to determine, for example, when clock slippage as between different platforms can be sufficiently leveraged as described above to then favor rescheduling of the first (i.e., next) monitoring of the beacon or supplemental beacon. For example, if the radio resource manager 706 determines that clock slippage will render a beacon or supplemental beacon of interest visible outside of an otherwise scheduled active window within an acceptable period of delay, then the radio resource manager 706 can elect that option; i.e., to reschedule the next beacon or supplemental beacon monitoring for that future time. As another example, if the radio resource manager 706 determines that clock slippage will not render beacon or supplemental beacon accessibility within an acceptable period of time, then the radio resource manager 706 can elect instead to alter, for example, the scheduling of the active window in order to temporally expose the beacon or supplemental beacon of interest. Or, and as yet another example, the radio resource manager 706 may elect to use both techniques simultaneously to achieve the desired result.

In a similar manner the radio resource manager 706 can be further configured and arranged to effect any and/or all of the other modes of operation as have been described above. So configured and arranged, the radio resource manager 706 will have considerably improved capabilities with respect to beacon or supplemental beacon monitoring in view of varying power saving and plesiochronous states of operation. This, in turn, should permit the radio resource manager 706 to have more current information available to it to thereby better inform its radio resource management goals.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a wireless two-way communications apparatus:
during a power saving mode of operation and while engaged in an active plesiochronous communication session with a first wireless access point:
upon determining that at least one of a beacon and a supplemental beacon as is transmitted by at least one of the first wireless access point and at least one other wireless access point is at least substantially coincident with at least one scheduled active window of the active plesiochronous communication session, automatically determining whether to facilitate at least one of:
rescheduling a first monitoring of the at least one of a beacon and a supplemental beacon at a future time when the at least one of a beacon and a supplemental beacon is at least largely not coincident with a scheduled active window of the active plesiochronous communication session; and
altering the at least one scheduled active window of the active plesiochronous communication session to provide an active window having an altered schedule such that the at least one of a beacon and a supplemental beacon is at least largely not coincident with the active window having the altered schedule.

2. The method of claim 1 wherein the active plesiochronous communication session comprises a Voice over Internet Protocol communication session.

3. The method of claim 1 wherein the first wireless access point comprises an 802.11-family compatible wireless access point.

4. The method of claim 1 further comprising:
determining that the at least one of a beacon and a supplemental beacon as is transmitted by at least one of the first wireless access point and at least one other wireless access point is at least substantially coincident with at least one scheduled active window of the active plesiochronous communication session as a function, at least in part, of information available to the wireless two-way communication apparatus regarding clock information for itself and for at least one of the first wireless access point and at least one other wireless access point.

5. The method of claim 1 wherein rescheduling a first monitoring of the at least one of a beacon and a supplemental beacon at a future time when the at least one of a beacon and a supplemental beacon is at least largely not coincident with a scheduled active window of the active plesiochronous communication session further comprises basing the rescheduling as a function, at least in part, of calculated slippage as between clocked behavior of the wireless two-way communication apparatus and the first wireless access point.

6. The method of claim 1 further comprising:
during a power saving mode of operation and while not engaged in an active plesiochronous communication session with a first wireless access point:
monitoring the at least one of a beacon and a supplemental beacon as is transmitted by at least one of the first wireless access point and at least one other wireless access point to thereby facilitate a radio resource management process.

7. The method of claim 1 further comprising:
during a non-power saving mode of operation and while not engaged in an active plesiochronous communication session with a first wireless access point:
to facilitate a radio resource management process, automatically determining whether to facilitate at least one of:
automatically shifting to a power saving mode of operation notwithstanding a need to maintain the non-power saving mode of operation, monitoring the at least one of a beacon and a supplemental beacon as is transmitted by at least one of the first wireless access point and at least one other wireless access point, and returning to the non-power saving mode of operation;
automatically monitoring the at least one of a beacon and a supplemental beacon as is transmitted by the at least one other wireless access point during the non-power saving mode of operation;
automatically shifting to a power saving mode of operation notwithstanding a need to maintain the non-power saving mode of operation, transmitting an active probe, monitoring a response to the active probe as is transmitted by at least one of the first wireless access point and at least one other wireless access point, and returning to the non-power saving mode of operation;
automatically transmitting an active probe during the non-power saving mode of operation and monitoring a response to the active probe as is transmitted by at least one of the first wireless access point and at least one other wireless access point.

8. The method of claim 1 further comprising:
during a non-power saving mode of operation and while engaged in an active plesiochronous communication session with a first wireless access point:
upon determining that a at least one of a beacon and a supplemental beacon as is transmitted by at least one of the first wireless access point and at least one other wireless access point is at least substantially coincident with at least one scheduled active window of the active plesiochronous communication session, automatically determining whether to facilitate at least one of:
remaining in the non-power saving mode of operation and rescheduling a first monitoring of the at least one of a beacon and a supplemental beacon at a future time when the at least one of a beacon and a supplemental beacon is at least largely not coincident with a scheduled active window of the active plesiochronous communication session;
automatically shifting to a power saving mode of operation and rescheduling a first monitoring of the at least one of a beacon and a supplemental beacon at a future time when the at least one of a beacon and a supplemental beacon is at least largely not coincident with a scheduled active window of the active plesiochronous communication session;
remaining in the non-power saving mode of operation and altering the at least one scheduled active window of the active plesiochronous communication session to provide an active window having an altered schedule such that the at least one of a beacon and a supplemental beacon is at least largely not coincident with the active window having the altered schedule; and
automatically shifting to a power saving mode of operation and altering the at least one scheduled active window of the active plesiochronous communication session to provide an active window having an altered schedule such that the at least one of a beacon and a supplemental beacon is at least largely not coincident with the active window having the altered schedule.

9. The method of claim 1 wherein automatically determining whether to facilitate at least one of rescheduling a first monitoring and altering the at least one scheduled active window further comprises automatically determining whether to facilitate both the rescheduling of the first monitoring and the altering of the at least one scheduled active window.

10. The method of claim 1 wherein automatically determining whether to facilitate at least one of rescheduling a first monitoring and altering the at least one scheduled active window further comprises automatically determining whether to facilitate at least one of:
the rescheduling of the first monitoring;
the altering of the at least one scheduled active window; and
transmitting an active probe to monitoring a response to the active probe.

11. A wireless two-way communications apparatus configured and arranged to have a power saving mode of operation while engaged in an active plesiochronous communication session with a first wireless access point, comprising:
clock information for at least two of the plurality of wireless access points;
a radio resource manager responsive to the clock information and being responsive to monitored beacons as are transmitted by a plurality of wireless access points, the radio resource manager being configured and arranged, upon determining that at least one of a beacon and a supplemental beacon as is transmitted by at least one of plurality of wireless access points is at least substantially coincident with at least one scheduled active window of an active plesiochronous communication session during the power saving mode of operation, to automatically determine whether to facilitate at least one of:
rescheduling a first monitoring of the at least one of a beacon and a supplemental beacon at a future time when the at least one of a beacon and a supplemental beacon is at least largely not coincident with a scheduled active window of the active plesiochronous communication session; and
altering the at least one scheduled active window of the active plesiochronous communication session to provide an active window having an altered schedule such that the at least one of a beacon and a supplemental beacon is at least largely not coincident with the active window having the altered schedule.

12. The wireless two-way communications apparatus of claim 11 wherein the clock information is stored in memory.

13. The wireless two-way communications apparatus of claim 11 wherein the radio resource manager is further configured and arranged, when operating during a power saving mode of operation and while not engaged in an active plesiochronous communication session with a first wireless access point, to monitor the at least one of a beacon and a supplemental beacon as is transmitted by at least one of the first wireless access point and at least one other wireless access point.

14. The wireless two-way communications apparatus of claim 11 wherein the radio resource manager is further configured and arranged, when operating during a non-power saving mode of operation and while not engaged in an active plesiochronous communication session with a first wireless access point, to automatically determine whether to facilitate at least one of:
automatically shifting to a power saving mode of operation notwithstanding a need to maintain the non-power saving mode of operation, monitoring the at least one of a beacon and a supplemental beacon as is transmitted by at least one of the first wireless access point and at least one other wireless access point, and returning to the non-power saving mode of operation;
automatically monitoring the at least one of a beacon and a supplemental beacon as is transmitted by the at least one other wireless access point during the non-power saving mode of operation;
automatically shifting to a power saving mode of operation notwithstanding a need to maintain the non-power saving mode of operation, transmitting an active probe, monitoring a response to the active probe as is transmitted by at least one of the first wireless access point and at least one other wireless access point, and returning to the non-power saving mode of operation;
automatically transmitting an active probe during the non-power saving mode of operation and monitoring a response to the active probe as is transmitted by at least one of the first wireless access point and at least one other wireless access point.

15. The wireless two-way communications apparatus of claim 11 wherein the radio resource manager is further configured and arranged, when operating during a non-power saving mode of operation and while engaged in an active plesiochronous communication session with a first wireless access point and upon determining that a at least one of a beacon and a supplemental beacon as is transmitted by at least one of the first wireless access point and at least one other wireless access point is at least substantially coincident with at least one scheduled active window of the active plesiochronous communication session, to automatically determine whether to facilitate at least one of:
remaining in the non-power saving mode of operation and rescheduling a first monitoring of the at least one of a beacon and a supplemental beacon at a future time when the at least one of a beacon and a supplemental beacon is at least largely not coincident with a scheduled active window of the active plesiochronous communication session;
automatically shifting to a power saving mode of operation and rescheduling a first monitoring of the at least one of a beacon and a supplemental beacon at a future time when the at least one of a beacon and a supplemental beacon is at least largely not coincident with a scheduled active window of the active plesiochronous communication session;
remaining in the non-power saving mode of operation and altering the at least one scheduled active window of the active plesiochronous communication session to provide an active window having an altered schedule such that the at least one of a beacon and a supplemental beacon is at least largely not coincident with the active window having the altered schedule; and
automatically shifting to a power saving mode of operation and altering the at least one scheduled active window of the active plesiochronous communication session to provide an active window having an altered schedule such that the at least one of a beacon and a supplemental beacon is at least largely not coincident with the active window having the altered schedule.

16. A wireless two-way communications apparatus configured and arranged to have a power saving mode of operation while engaged in an active plesiochronous communication session with a first wireless access point, comprising:
means for use during a power saving mode of operation and while engaged in an active plesiochronous communication session with a first wireless access point for determining that a at least one of a beacon and a supplemental beacon as is transmitted by at least one of the first wireless access point and at least one other wireless access point is at least substantially coincident with at least one scheduled active window of the active plesiochronous communication session and for automatically determining whether to facilitate at least one of:
rescheduling a first monitoring of the at least one of a beacon and a supplemental beacon at a future time when the at least one of a beacon and a supplemental beacon is at least largely not coincident with a scheduled active window of the active plesiochronous communication session; and
altering the at least one scheduled active window of the active plesiochronous communication session to provide an active window having an altered schedule such that the at least one of a beacon and a supplemental beacon is at least largely not coincident with the active window having the altered schedule.

17. The wireless two-way communications apparatus of claim 16 further comprising:
means for use during a power saving mode of operation and while not engaged in an active plesiochronous communication session with a first wireless access point for monitoring the at least one of a beacon and a supplemental beacon as is transmitted by at least one of the first wireless access point and at least one other wireless access point to thereby facilitate a radio resource management process.

18. The wireless two-way communications apparatus of claim 16 further comprising:
means for use during a non-power saving mode of operation and while not engaged in an active plesiochronous communication session with a first wireless access point for facilitating a radio resource management process by automatically determining whether to facilitate at least one of:
automatically shifting to a power saving mode of operation notwithstanding a need to maintain the non-power saving mode of operation, monitoring the at least one of a beacon and a supplemental beacon as is transmitted by at least one of the first wireless access point and at least one other wireless access point, and returning to the non-power saving mode of operation;
automatically monitoring the at least one of a beacon and a supplemental beacon as is transmitted by the at least one other wireless access point during the non-power saving mode of operation;
automatically shifting to a power saving mode of operation notwithstanding a need to maintain the non-power saving mode of operation, transmitting an active probe, monitoring a response to the active probe as is transmitted by at least one of the first wireless access point and at least one other wireless access point, and returning to the non-power saving mode of operation;
automatically transmitting an active probe during the non-power saving mode of operation and monitoring a response to the active probe as is transmitted by at least one of the first wireless access point and at least one other wireless access point.

19. The wireless two-way communications apparatus of claim 16 further comprising:
means for use during a non-power saving mode of operation and while engaged in an active plesiochronous communication session with a first wireless access point for determining that at least one of a beacon and a supplemental beacon as is transmitted by at least one of the first wireless access point and at least one other wireless access point is at least substantially coincident with at least one scheduled active window of the active plesiochronous communication session and for automatically determining whether to facilitate at least one of:
remaining in the non-power saving mode of operation and rescheduling a first monitoring of the at least one of a beacon and a supplemental beacon at a future time when the at least one of a beacon and a supplemental beacon is at least largely not coincident with a scheduled active window of the active plesiochronous communication session;
automatically shifting to a power saving mode of operation and rescheduling a first monitoring of the at least one of a beacon and a supplemental beacon at a future time when the at least one of a beacon and a supplemental beacon is at least largely not coincident with a scheduled active window of the active plesiochronous communication session;
remaining in the non-power saving mode of operation and altering the at least one scheduled active window of the active plesiochronous communication session to provide an active window having an altered schedule such that the at least one of a beacon and a supplemental beacon is at least largely not coincident with the active window having the altered schedule; and
automatically shifting to a power saving mode of operation and altering the at least one scheduled active window of the active plesiochronous communication session to provide an active window having an altered schedule such that the at least one of a beacon and a supplemental beacon is at least largely not coincident with the active window having the altered schedule.
